(19) United States
(12) Patent Application Publication
(10) Pub. No.: US 2010/0259523 A1
(43) Pub. Date: Oct. 14, 2010

(54) SOURCE DRIVER

(75) Inventors: Da-Rong Huang, Tainan County (TW); Chien-Ru Chen, Tainan County (TW)

Correspondence Address: J C PATENTS, 4 VENTURE, SUITE 250, IRVINE, CA, 92618, US

(73) Assignee: HIMAX TECHNOLOGIES LIMITED, Tainan County (TW)

(21) Appl. No.: 12/421,067

(22) Filed: Apr. 9, 2009

(51) Int. Cl. G09G 5/00

(52) U.S. Cl. 345/211

(57) ABSTRACT

A source driver adaptive to driving a plurality of data lines on a display panel is provided herein. The source driver includes a plurality of channels and an output switch. The channels generate driving voltages to drive the display panel. The output switch includes a plurality of output multiplexers, so as to selectively connect the channels to data lines of the display. Each of the output multiplexers connects at least one of the channels to one of the data lines while being activated, wherein the output multiplexers are sequentially activated within a frame period. The source driver utilizes the output switch to sequentially delay a control signal, for controlling the output multiplexers to be sequentially activated within the frame period. Therefore, an electromagnetic interference can be reduced for ensuring the source driver operates normally.

### BACKGROUND OF THE INVENTION

1. Field of the Invention

The present invention relates to a source driver, and more particularly to a source driver for reducing electromagnetic interference (EMI) generated in the source driver.

2. Description of Related Art

A liquid crystal display (LCD) has a lot of advantages such as light weight, small size, low power consumption and little radiation, and has been widely used in recent years.

FIG. 1 is a diagram of a conventional LCD. As shown in FIG. 1, the LCD 100 includes a display panel 102, a gate driver 104 and a source driver 106. The display panel 102 includes a pixel array constructed by a plurality of pixels 111. The gate driver 104 sequentially enables scan line S₁ through S_{M}, and then the source driver 106 transmits driving voltages, converted from digital video data, to the pixels 111 on the enabled scan line via data lines D₁ through D_{N} for displaying a frame. The source driver 106 mainly includes digital-to-analog converters (DAC), output buffers and output multiplexers. The DAC converts the digital video data into the driving voltage and delivers the driving voltage to the output buffer for enhancing the driving ability of the driving voltage and transmitting the driving voltage to the pixel 111 on the display panel 102.

Generally, the pixels 111 are usually driven by polarity inversion to prevent polarization of liquid crystal, caused by residual charges stored within the pixels 111, and to enhance the display quality. The pixels 111 in the same location of two sequential frames are driven by the driving voltages with different polarities, e.g., positive and negative, and even the neighboring pixels 111 in the same frame are driven by driving voltages with different polarities. In the source driver 106, the driving voltage outputted from the output buffer swings between the positive polarity voltage and the negative polarity voltage, so that the power consumption is higher.

In order to reduce the power consumption, the output buffers are designed to respectively enhance the driving abilities of the driving voltages with positive polarity and negative polarity. By the operation of the output multiplexers, the driving voltages with positive and negative polarity are outputted together to the pixels 111 via the data lines D₁ through D_{N}. At present, without considering the line loading would affect the signal transmission, the output multiplexers controlled by a control signal are simultaneously activated to output the driving voltages, but an electromagnetic interference (EMI) is thereby produced in the source driver 106 due to a instantly large current. The electromagnetic interference would limit the performance of the source driver 106 and result in the abnormal operation of the LCD. Therefore, the source driver is desirable to have a circuit design for solving the said problem.

### SUMMARY OF THE INVENTION

Accordingly, the present invention is related to a source driver for reducing electromagnetic interference (EMI) generated from the source driver. Therefore, a display panel with the provided source driver can conform to the safe criterion for EMI.

One exemplary embodiment consistent with the present invention provides a source driver adaptive to driving a display panel, wherein the source driver includes a plurality of channels and an output switch. The channels generate driving voltages to drive the display panel. The output switch includes a plurality of output multiplexers, so as to selectively connect the channels to data lines of the display. Each of the output multiplexers connects at least one of the channels to one of the data lines while being activated, wherein the output multiplexers are sequentially activated within a frame period.

The source driver according to one exemplary embodiment consistent with the present invention utilizes the output switch to selectively connect the channels to data lines of the display, for controlling the output multiplexers to be sequentially activated within the frame period. Therefore, when driving pixels on the display panel, an instantly large current will not be induced in the source driver so as to reduce an electromagnetic interference (EMI).

In order to make the features and advantages of the present invention comprehensible, preferred embodiments accompanied with figures are described in detail below. It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional LCD.

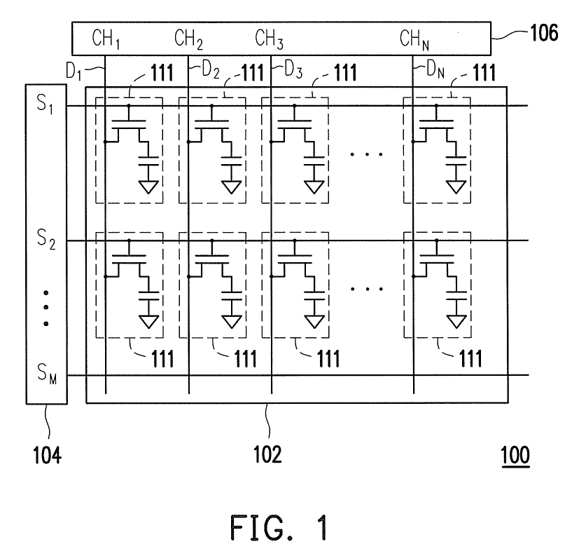

FIG. 2 is a block diagram of a source driver according to an embodiment of the present invention.

FIG. 3 illustrates a timing diagram of the control signal CON and the delayed control signals D_1 through D_N.

FIG. 4 is a circuit diagram of the output multiplexer in the source driver according to an embodiment of the present invention.

FIG. 5 is a block diagram of a source driver according to an embodiment of the present invention.

FIG. 6 is a block diagram of a source driver according to an embodiment of the present invention.

FIG. 7 is a block diagram of a source driver according to an embodiment of the present invention.

### DESCRIPTION OF EMBODIMENTS

As known, the source driver includes a plurality of driving channels for respectively driving pixels on each data line during different scan periods. Each driving channel of the source driver 200 may include a shift register for controlling a data latch to receive a video data in accordance with timing control, a digital-to-analog converter for converting the video data into an analog voltage, an output buffer for enhancing the analog voltage, and etc. In addition, the post-end of the source driver further includes a plurality of output multiplexers for simultaneously transmitting the analog voltages of the driving channels to the pixels on a display panel in response a control signal (which may be generated from a timing controller). In order to reduce an electromagnetic interference (EMI) caused by instantly outputting the analog voltages, an embodiment of the present invention teaches a circuit design for controlling the output multiplexers. People ordinarily skilled in the art realize the operation of the said components in the source driver, so that details related to the connection between the said components in the source driver are not described herein.

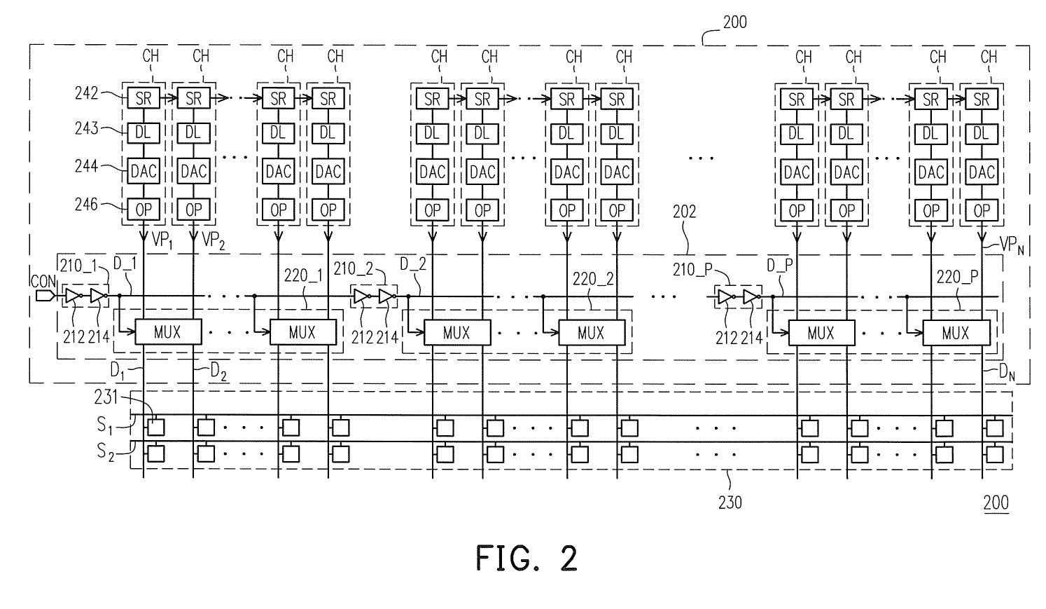

FIG. 2 is a block diagram of a source driver according to an embodiment of the present invention. Referring to FIG. 2, the source driver 200, adaptive to driving a plurality of data lines D₁ through D_{N} on a display panel 230, includes a plurality of channels CHs and an output switch 202, wherein the data lines D₁ through D_{N} includes a plurality of odd data lines and a plurality of even data lines. The output switch 202 includes a plurality of delay units 210_1 through 210_N and a plurality of output multiplexer sets 220_1 through 220_N. The output switch 202 is coupled to the channels, and selectively connects the driving channels CHs to the data lines D₁ through D_{N}. The driving channels CHs respectively drive the N pixel cells 231 on the scan lines S₁ through S_{M}. Each driving channel respectively includes a shift register 242, a data latch 243, a digital-analog converter (DAC) 244, and an output buffer 246. The driving channels CHs respectively receive pixel data DP₁ through DP_{N}. The DACs 244 included in the driving channels CHs respectively convert the pixel data DP₁ through DP_{N} into pixel signals VP₁ through VP_{N}. Then, the driving channels CHs respectively output the pixel signals VP₁ through VP_{N} to output multiplexers MUX via a plurality of output buffers 246. The operation detail of each driving channel is known by those skilled in the art, so it is not described here.

Each of the output multiplexer sets 220_1 through 220_N includes the output multiplexers MUX. Each of the output multiplexers MUX is coupled to the corresponding channels, and connects at least one of the corresponding channels to one of the data lines while being activated wherein the output multiplexers are sequentially activated within a frame period. For example, the first output multiplexer MUX is coupled to the first and the second channels CHs, and connects the first and the second channels CHs to the data lines D₁ and D₂ while being activated.

A first input terminal and a second input terminal of each output multiplexer respectively receive a first pixel signal VP₁ and a second pixel signal VP₂ from the output buffers 246 of the source driver, wherein the first pixel signal VP₁ and the second pixel signal VP₂ may have complementary polarities in one embodiment, i.e. positive polarity and negative polarity, for performing polarity inversion. A first output terminal and a second output terminal of each output multiplexer respectively coupled to one of the odd data line (e.g. the data line D₁) and one of the even data line (e.g. the data line D₂). When performing polarity inversion on the display panel, such as column inversion or dot inversion, each output multiplexers MUX, activated by a control signal CON, transmits the first pixel signal VP₁ and the second pixel signal VP₂ to the odd data line and the even data line or transmits the first pixel signal VP₁ and the second pixel signal VP₂ to the even data line and the odd data line.

The delay units 210_1 through 210_N are coupled in series for successively delaying the control signal CON and thereby respectively generate a plurality of delayed control signals D_1 through D_N to the output multiplexer sets 220_1 through 220_N. The output multiplexer sets 220_1 through 220_N are sequentially driven to operate according to the delayed control signals D_1 through D_N respectively. In this embodiment, each delay unit is implemented by two inverters 212 and 214 connected in series. People ordinarily skilled in the art can utilize other components, such as logic gates, routing wires, and etc. to implement each delay unit, so that the present invention is not limited thereto.

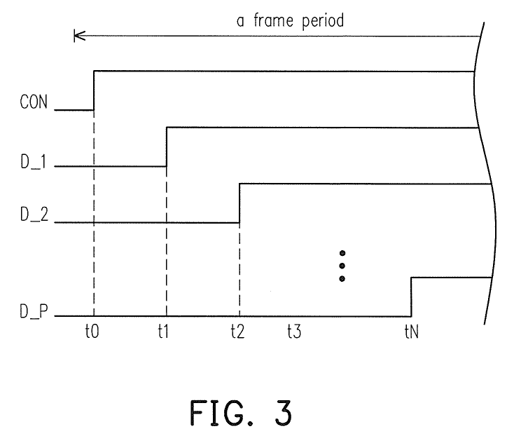

FIG. 3 is a timing diagram of the control signal CON and the delayed control signals D_1 through D_N in a frame period according to the embodiment of the present invention in FIG. 2. In the embodiment of the present invention, it is assumed that the control signal CON being in logic high level can activate the output multiplexer MUX to output the first pixel signal VP₁ and the second pixel signal VP₂ to the data lines of the display panel in the frame period, but people ordinarily skilled in the art can design the logic state of the control signal CON for requirements. Referring to FIG. 2 and FIG. 3, the delay unit 210_1 delays the control signal CON for generating the delayed control signal D_1 at time t1, and in the meanwhile, the output multiplexers MUX in the output multiplexer set 220_1 are substantially simultaneous to transmit the pixel signals from the corresponding output buffers to the pixels on the display panel. The delay unit 210_2 delays the delayed control signal D_1 for generating the delayed control signal D_2 at time t2, and in the meanwhile, the output multiplexers MUX in the output multiplexer set 220_2 are substantially simultaneous to transmit the pixel signals from the corresponding output buffers to the pixels on the display panel. To reason by analogy, the other delay units and output multiplexer sets have similar operation. Since the output multiplexer sets 220_1 through 220_N controlled by different delayed control signals are activated at different time, the output multiplexers MUX are sequentially activated within the frame period. Accordingly, the instant current induced in the source driver can be lowered so as to reduce the electromagnetic interference.

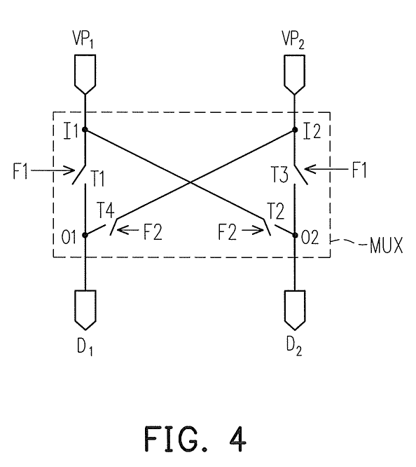

FIG. 4 is a circuit diagram of the output multiplexer MUX in the source driver 200 according to the embodiment of the present invention in FIG. 2. Referring to FIG. 2 and FIG. 4, the output multiplexer MUX includes switches T1 through T4. The switches T1 and T3 conduct the first input terminal I1 and the second input terminal I1 of the output multiplexer MUX to the first output terminal O1 and the second output terminal O2 of the output multiplexer MUX according to a first control signal F1. The switches T2 and T4 conduct the first input terminal I1 and the second input terminal I1 of the output multiplexer MUX to the second output terminal O2 and the first output terminal O1 of the output multiplexer MUX according to a second control signal F2. In the embodiment of the present invention, the control signal CON is the first control signal F1 or the second control signal F2, and the first control signal F1 and the second control signal F2 are inverted each other. Thereby, when the output multiplexer MUX is activated by the control signal CON, the output multiplexer MUX transmits the first pixel signal VP₁ and the second pixel signal VP₂ to the odd data line D₁ and the even data line D₂ respectively, or transmits the first pixel signal VP₁ and the second pixel signal VP₂ to the even data line D₂ and the odd data line D₁ respectively.

In another embodiment of the present invention, the switches T1 through T4 can be implemented by transistors. For example, if the first pixel signal VP₁ has positive polarity, and the second pixel signal VP₂ has negative polarity, the switches T1 and T2 can be implemented by N-type metal-oxide-semiconductor (NMOS) transistors and the switches T3 and T4 can be implemented by PMOS transistors for avoiding the body effect of the transistors. As a result, the first control signal F1 should control the conduction states of the switches T1 and T4, and the second control signal F2 should control the conduction states of the switches T2 and T3, wherein the first control signal and the second control signal are inverted each other.

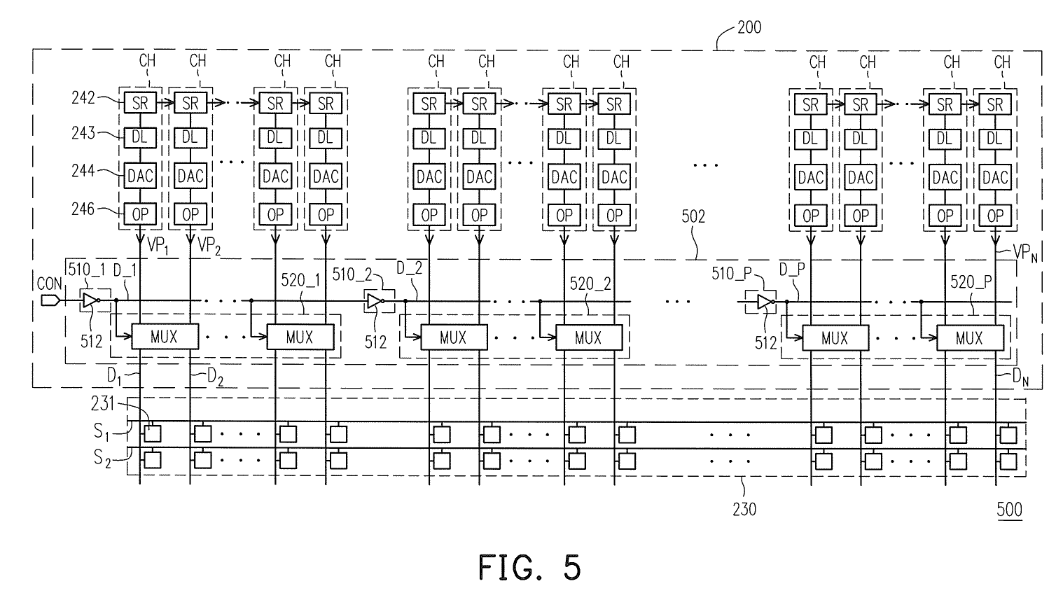

FIG. 5 is a block diagram of a source driver according to an embodiment of the present invention. Referring to and FIG. 5, each of the delay unit 510_1 through 510_N can be implemented by an inverter 512 for sequentially delaying the control signal CON. The operation of the embodiment in FIG. 5 is similar to the operation of the embodiment in FIG. 3 so that the detail is not iterated. As the foregoing description that the output multiplexer MUX is activated by the control signal CON, the design of using one inverter 512 to implement the delay unit should properly modify the control manner of the output multiplexer MUX. That is to say the output multiplexer set 520_1 is activated by the delayed control signal D_1, the output multiplexer set 520_2 is activated by the delayed control signal D_2, which is inverted from the delayed control signal D_1, and so on.

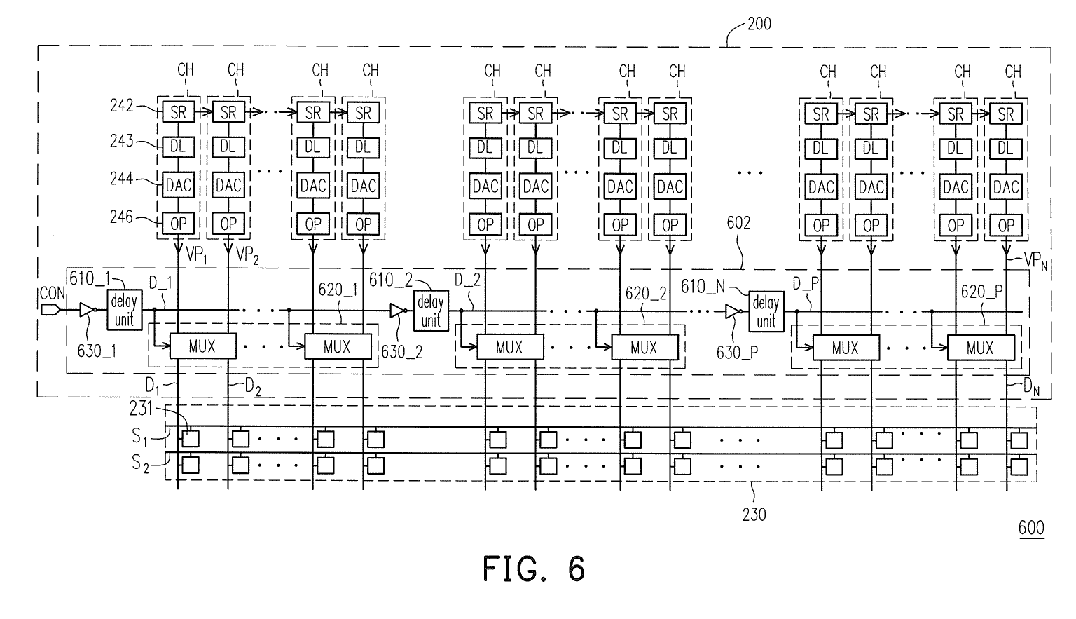

FIG. 6 is a block diagram of a source driver according to an embodiment of the present invention. Referring to FIG. 2 and FIG. 6, the difference between the embodiments in FIG. 2 and FIG. 6 is that the output switch 602 of the source driver 600 further includes a plurality of inverters 630_1 through 630_N coupled to the delay units 610_1 through 610_N respectively to avoid the delayed control signal attenuating during signal transmission.

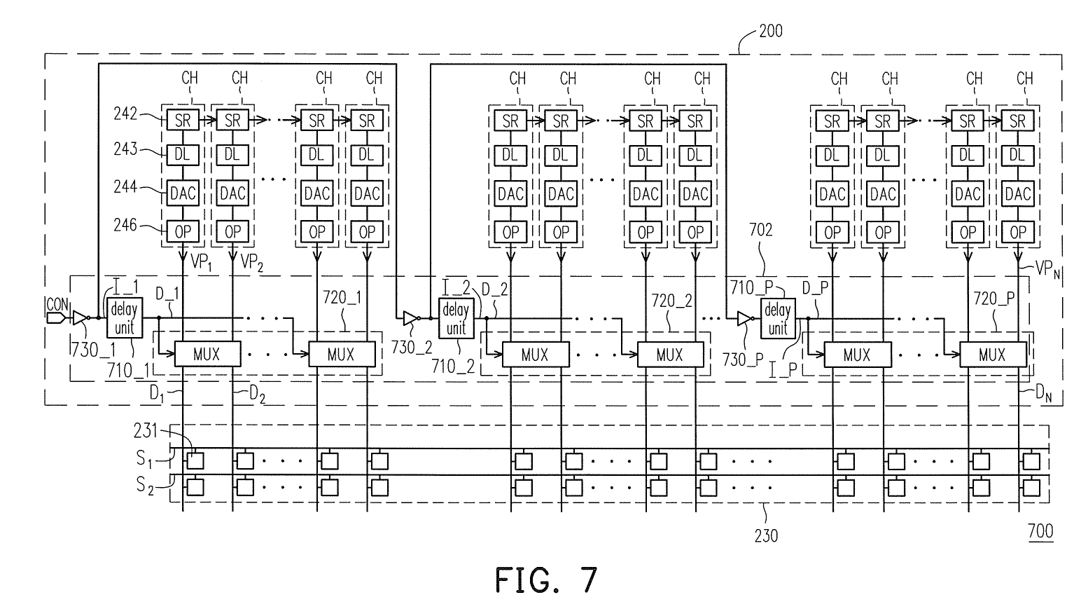

FIG. 7 is a block diagram of a source driver according to an embodiment of the present invention. Referring to FIG. 7, the output switch 702 of the source driver 700 includes a plurality of inverters 730_1 through 730_N, a plurality of delay units 710_1 through 710_N, and a plurality of output multiplexer sets 720_1 through 720_N. The inverters 730_1 through 730_N are coupled in series for generating a plurality of inverted control signals I_1 through I_N according to a control signal CON. The delay units 710_1 through 710_N delay the inverted control signals I_1 through I_N for generating a plurality of delayed control signals D_1 through D_N, respectively. The operation of the embodiment is similar to the said embodiments in FIG. 2, FIG. 5 and FIG. 6, which sequentially activate the output multiplexer sets 720_1 through 720_N at different time for reducing the electromagnetic interference. In the embodiment of the present invention, each inverter directly transmits the inverted control signal to the next inverter instead of transmitting the inverted control signal to the next inverter through the corresponding delay unit and the routing wire coupled to the output multiplexers MUX, like the embodiment in FIG. 6. Hence, this embodiment of FIG. 7 can reduce the loading effect to affect the variation of the inverted control signal.

In summary, the source driver in the said embodiment utilizes the delay units to sequentially delay the control signal, and thus the output multiplexer sets are driven to operate at different time. As a result, an instantly large current will not be induced in the source driver for reducing the electromagnetic interference. In addition, through the inverter connected with each delay unit, the intensity of the delayed control signal can be enhanced during signal transmission.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driver, adaptive to driving a display panel, comprising:
a plurality of channels for generating driving voltages; and
an output switch, coupled to the channels and selectively connecting the channels to data lines of the display, the output switch comprising:
a plurality of output multiplexers, each of the output multiplexers coupled to the corresponding channels, and connecting at least one of the corresponding channels to one of the data lines while being activated,
wherein the output multiplexers are sequentially activated within a frame period.

2. The source driver as claimed in claim 1, wherein the output switch further comprises: a plurality of delay units, coupled in series for successively delaying a control signal and respectively generating a plurality of delayed control signals.

3. The source driver as claimed in claim 2, wherein the output multiplexers form a plurality of output multiplexer sets, and the output multiplexer sets respectively receiving the delayed control signals, and each of the output multiplexer set.

4. The source driver as claimed in claim 3, wherein each of the output multiplexers has a first input terminal, a second input terminal, a first output terminal and a second output terminal, wherein the first input terminal and the second input terminal respectively receive a first pixel signal and a second pixel signal, and the first output terminal and the second output terminal are respectively coupled to one of the odd data lines and one of the even data lines, so that each of the output multiplexers selectively transmits the first pixel signal and the second pixel signal to the one of the odd data lines and the one of the even data lines respectively, or to the one of the even data lines and the one of the odd data lines respectively according to the delayed control signal received by each of the output multiplexer sets.

5. The source driver as claimed in claim 2, wherein the output switch further comprises:
a plurality of inverters, each of the inverters having an input terminal and an output terminal, the input terminal of the 1^{st} inverter receiving the control signal, the output terminal of the 1^{st} inverter coupled to the 1^{st} delay unit, the input terminal of the i^{th} inverter receiving the delayed control signal generated by the (i-1)^{th} delay unit and the output terminal of the i^{th} inverter coupled to the i^{th} delay unit, wherein 2≦i≦N and N is the number of the delay units.

6. The source driver as claimed in claim 3, wherein each of the output multiplexers comprises:
a first switch, having a first terminal serving as the first input terminal of each of the output multiplexers and a second terminal coupled to the one of the odd data lines for conducting the first terminal thereof to the second terminal thereof according a first control signal;
a second switch, having a first terminal coupled to the first terminal of the first switch and a second terminal coupled to the one of the even data lines for conducting the first terminal thereof to the second terminal thereof according to the first control signal;
a third switch, having a first terminal serving as the second input terminal of each of the output multiplexers and a second terminal coupled to the one of the even data lines for conducting first terminal thereof to the second terminal thereof according to a second control signal; and
a fourth switch, having a first terminal coupled to the first terminal of the third switch and a second terminal coupled to the one of the odd data lines for conducting first terminal thereof to the second terminal thereof according to the second control signal;
wherein the first control signal and the second control signal are inverted each other and the delayed control signal received by each of the output multiplexer sets is the first control signal or the second control signal.

7. The source driver as claimed in claim 5, wherein the first inverted control signal is inverted from the first control signal, and the second inverted control signal is inverted from the second control signal.

8. The source driver as claimed in claim 5, wherein the first through the fourth switches are transistors.

9. The source driver as claimed in claim 3, wherein each of the delay units comprises:
a first inverter, having an input terminal and an output terminal, the input terminal of the first inverter in the 1^{st} delay unit receiving the control signal, the output terminal of the first inverter in 1^{st} delay unit generating the 1^{st} delayed control signal, the input terminal of the first inverter in the i^{th} delay unit receiving the (i-1)^{th} delayed control signal and the output terminal of the first inverter in the i^{th} delay unit generating the i^{th} delayed control signal wherein 2≦i≦N and N is the number of the output multiplex sets.

10. The source driver as claimed in claim 2, wherein each of the delay units comprises:
a first inverter, having an input terminal and an output terminal, the input terminal of the first inverter in the 1^{st} delay unit receiving the control signal and the input terminal of the first inverter in the i^{th} delay unit receiving the (i-1)^{th} delayed control signal, wherein 2≦i≦N and N is the number of the delay units; and
a second inverter, having an input terminal coupled to the output terminal of the first inverter, the output terminal of the second inverter in the 1^{st} delay unit generating the 1^{st} delayed control signal and the output terminal of the second inverter in the i^{th} delay unit generating the i^{th} delayed control signal.

11. The source driver as claimed in claim 1, wherein the output switch further comprises:
a plurality of inverters, coupled in series for generating a plurality of inverted control signals according to a control signal; and
a plurality of delay units, respectively delaying the inverted control signals and generating a plurality of delayed control signals.

12. The source driver as claimed in claim 11, wherein the output multiplexers form a plurality of output multiplexer sets, and the output multiplexer sets respectively receiving the delayed control signals, and each of the output multiplexer set.

13. The source driver as claimed in claim 12, wherein each of the output multiplexers has a first input terminal, a second input terminal, a first output terminal and a second output terminal, wherein the first input terminal and the second input terminal respectively receive a first pixel signal and a second pixel signal, and the first output terminal and the second output terminal are respectively coupled to one of the odd data lines and one of the even data lines, so that each of the output multiplexers selectively transmits the first pixel signal and the second pixel signal to the one of the odd data lines and the one of the even data lines respectively, or to the one of the even data lines and the one of the odd data lines respectively according to the delayed control signal received by each of the output multiplexer sets.

14. The source driver as claimed in claim 11, wherein each of the output multiplexers comprises:
a first switch, having a first terminal serving as the first input terminal of each of the output multiplexers and a second terminal coupled to the one of the odd data lines for conducting the first terminal thereof to the second terminal thereof according a first control signal;
a second switch, having a first terminal coupled to the first terminal of the first switch and a second terminal coupled to the one of the even data lines for conducting the first terminal thereof to the second terminal thereof according to the first control signal;
a third switch, having a first terminal serving as the second input terminal of each of the output multiplexers and a second terminal coupled to the one of the even data lines for conducting first terminal thereof to the second terminal thereof according to a second control signal; and
a fourth switch, having a first terminal coupled to the first terminal of the third switch and a second terminal coupled to the one of the odd data lines for conducting first terminal thereof to the second terminal thereof according to the second control signal;
wherein the first control signal and the second control signal are inverted each other and the delayed control signal received by each of the output multiplexer sets is the first control signal or the second control signal.

15. The source driver as claimed in claim 14, wherein the first inverted control signal is inverted from the first control signal, and the second inverted control signal is inverted from the second control signal.

16. The source driver as claimed in claim 14, wherein the first through the fourth switches are transistors.

17. The source driver as claimed in claim 11, wherein each of the delay units comprises:
a first inverter, having an input terminal and an output terminal, the input terminal of the first inverter in the 1^{st} delay unit receiving the control signal and the input terminal of the first inverter in the i^{th} delay unit receiving the (i-1)^{th} delayed control signal, wherein 2≦i≦N and N is the number of the delay units; and
a second inverter, having an input terminal coupled to the output terminal of the first inverter, the output terminal of the second inverter in the 1^{st} delay unit generating the 1^{st} delayed control signal and the output terminal of the second inverter in the i^{th} delay unit generating the i^{th} delayed control signal.

18. The source driver as claimed in claim 1, wherein the first pixel signal and the second pixel signal have complementary polarities.

19. The source driver as claimed in claim 1, wherein the first pixel signal and the second pixel signal have different colors.
